(19) United States
(12) Patent Application Publication
(10) Pub. No.: US 2025/0178625 A1
(43) Pub. Date: Jun. 5, 2025

(54) DRIVE SYSTEM FOR A VEHICLE

(71) Applicant: AUDI AG, Ingolstadt (DE)

(72) Inventor: Manuel PAßLER, Weißenburg (DE)

(73) Assignee: AUDI AG, Ingolstadt (DE)

(21) Appl. No.: 18/844,208

(22) PCT Filed: Mar. 2, 2023
(86) PCT No.: PCT/EP2023/055259

§ 371 Date: Sep. 5, 2024

(30) Foreign Application Priority Data
May 4, 2022 (DE) 102022110952.6

(51) Int. Cl. B60W 50/10; B60W 50/04; G07C 5/08

(52) U.S. Cl. CPC B60W 50/10; B60W 50/045; G07C 5/0808; B60W 2540/103

(57) ABSTRACT

A drive system for a vehicle, including an accelerator pedal having an associated accelerator pedal control unit which carries out a driving task when the driver actuates the accelerator pedal. The accelerator pedal control unit is connected as a transmitter control unit to an assistance control unit as a receiver control unit which carries out a driver-independent, automated driving task. The assistance control unit in particular deactivates the driver-independent, automated driving task when a valid kickdown actuation by the driver is present.

### FIELD

The invention relates to a drive system for a vehicle and a method for operating such a drive system.

### BACKGROUND

A vehicle of this type has an assistance function or a piloted function which takes over driving operation from the driver when activated. If the driver deactivates the assistance function, the driver will take over. The drive system of the vehicle has an accelerator pedal having an associated accelerator pedal control unit, which performs a driving task when the driver actuates the accelerator pedal. The accelerator pedal control unit is connected to an assistance control unit that performs the assistance function. If the driver actuates a kickdown, the assistance function or the piloted function is deactivated so that the driver is again responsible for taking over the driving task.

In the above assistance system, a fully depressed accelerator pedal (kickdown) therefore has to be identified in order to detect the driver takeover. In contrast, only light actuation of the accelerator pedal cannot result in deactivation of the assistance function. The detection and evaluation of the accelerator pedal information in the assistance control unit are therefore highly relevant to safety. This is because if a driver takeover were incorrectly detected, the assistance function would switch off although the driver may not be ready to take over. In the prior art, all components, beginning with the acquisition of the accelerator pedal raw values, their processing, and up to the output, are therefore developed with the highest safety integrity (ASIL=automotive safety integrity level), so that the required information reaches the assistance control unit with the required safety integrity (ASIL). The required safety integrity of each component results in very high process and technical requirements.

A method and a device for determining a driver desire are known from DE 101 50 422 A1. A device for acquiring an actuation of an accelerator pedal of a motor vehicle is known from DE 10 2016 011 175 A1. A brake pedal system for an electronically controlled vehicle brake is known from WO 2020/180140 A1.

### SUMMARY

The object of the invention is to provide an assistance system for a vehicle and a method for operating such an assistance system, which is producible with reduced expenditure in comparison to the prior art, without compromising safety integrity.

It is to be emphasized that the invention primarily relates to a drive system in which a kickdown actuation, by means of which a driver-independent automated driving task is deactivatable, is detectable with high safety integrity. However, the invention is not restricted to this special application. Rather, the invention is also generally applicable to the detection of an accelerator pedal actuation. However, for reasons of easier comprehension, reference is made hereinafter, for example, to the detection of a kickdown actuation:

The invention is directed to a drive system that has an accelerator pedal control unit having an associated accelerator pedal. If the driver actuates the accelerator pedal, a driving task is performed by the driver. The accelerator pedal control unit is connected as a transmitter control unit to an assistance control unit as a receiver control unit. The assistance control unit can perform a driver-independent, automated driving task.

If a driver kickdown actuation is present, the assistance function or the piloted function is deactivated, so that the driver is again responsible for taking over the driving task. For a reliable detection of such a kickdown actuation using the accelerator pedal, the following measures are taken according to the characterizing part of claim 1: Two accelerator pedal sensors are assigned to the accelerator pedal. The first accelerator pedal sensor acquires a first pedal raw value, while the second pedal sensor acquires a second pedal raw value independently thereof in parallel operation. The first accelerator pedal sensor is connected to the accelerator pedal control unit via a first signal path and, in the further course of the signal, to the assistance control unit. In the same way, the second accelerator pedal sensor is also connected to the accelerator pedal control unit via a second signal path and, in the further course of the signal, to the assistance control unit. If the signal processing is error-free, the two accelerator pedal sensors acquire a kickdown actuation by the driver. Accordingly, a kickdown signal is generated in each signal path. In the assistance control unit, error-free signal processing in the signal paths is checked by checking the plausibility of the two kickdown signals.

Using the signal processing according to the invention, the safety integrity of the accelerator pedal control unit can be reduced. By way of skilled signal processing and a plausibility check in the assistance control unit (i.e. the receiver control unit), parts of the chain of effects (i.e. the accelerator pedal control unit) can be developed with a lower safety integrity requirement (i.e. ASIL B, for example) in comparison to the accelerator pedal and the assistance control unit. On the other hand, the accelerator pedal and the assistance control unit are developed with a higher safety integrity requirement (i.e. ASIL D, for example).

The signal paths from the accelerator pedal to the assistance control unit are described hereinafter: The accelerator pedal raw value, which is available with ASIL B(D) quality, for example, can be conducted uncorrupted from one of the accelerator pedal sensors to the assistance control unit (receiver control unit).

Together with the accelerator pedal information processed in the accelerator pedal control unit, these two pieces of information can be meaningfully linked in the assistance control unit so that in the end a required high safety integrity ASIL D (see decomposition rules of ISO 26262) is achieved.

The accelerator pedal control unit routes one of the two ASIL B(D) pieces of information of the accelerator pedal (accelerator pedal raw values) to the assistance control unit (i.e. receiving control unit), together with the items of test information checksum and message counter.

For example, the following error case can occur in signal processing: Since the accelerator pedal control unit is less trustworthy (i.e. has a lower safety integrity), the message is corrupted during routing. According to the invention, the error determination is carried out as follows: The assistance control unit (receiver control unit) receives the processed accelerator pedal information from the accelerator pedal control unit (transmitter control unit) with integrity ASIL B(D) via the first signal path. In addition, the receiver control unit receives the raw information of the other accelerator pedal sensor via a second signal path with ASIL B(D) and can form the same information with ASIL B(D). To obtain kickdown information with ASIL D, the results from the first signal path and the second signal path have to be linked. In order for the assistance control unit to be able to detect a corruption of the accelerator pedal raw value in the second signal path, the assistance control unit has to check the integrity of the accelerator pedal information using the additionally received test information (message counter, checksum).

As already mentioned above, it is to be emphasized that in addition to the information “kickdown”, the information “accelerator pedal actuated” or “accelerator pedal not actuated” can also be mapped in general using the same method.

In a technical implementation, the signal processing in the first signal path can be performed as follows: The accelerator pedal control unit can have a comparator module that compares the first accelerator pedal raw value with a kickdown limiting value. The comparator module sets the kickdown signal to “kickdown performed” (i.e. K1=yes) if the first accelerator pedal raw value is greater than the kickdown limiting value. In addition, latent error diagnosis can be carried out in the accelerator pedal control unit. In latent error diagnosis, a diagnostic module compares the first and second accelerator pedal raw values with one another. The diagnostic module detects a latent error if there is a significant deviation between the two accelerator pedal raw values. In this case, the diagnostic module sets a piece of diagnostic information to an error value. Alternatively, if both accelerator pedal raw values correspond, the diagnostic module does not detect any latent error, so the diagnostic module sets the diagnostic information to an error-free value. The diagnostic information generated in the diagnostic module is added to the first kickdown signal. It is to be emphasized that according to ISO 26262, latent fault diagnostics may be performed with lower integrity. Against this background, the latent fault diagnosis according to the invention can be easily carried out in the accelerator pedal control unit, which is preferably developed with a lower safety integrity requirement (i.e. for example, ASIL B) in comparison to the accelerator pedal and the assistance control unit.

In a further technical implementation, the signal processing in the second signal path can be carried out as follows: In the second signal path in the accelerator pedal control unit, routing can take place in which the second accelerator pedal raw value is transmitted to the assistance control unit without signal processing. In this case, signal processing of the second accelerator pedal raw value is only carried out in the assistance control unit. This is carried out using a comparator module that compares the second accelerator pedal raw value with the kickdown limiting value. The comparator module sets the kickdown signal to “kickdown performed” (i.e. K2=yes) if the second accelerator pedal raw value is greater than the kickdown limiting value.

Preferably, the second signal path can have end-to-end protection. End-to-end protection can be used to identify a signal transmission error in the second signal path that results from erroneous routing in the accelerator pedal control unit. The end-to-end protection can in principle be structured as described in EP 2 454 864 B1, to which reference is hereby made. For example, the end-to-end protection in the assistance control unit can have a checking module that performs protection by checking a checksum and a message count value.

The end-to-end protection is described hereinafter as an example for the second signal path: For the checksum check, a transmitter calculation module (assigned to the accelerator pedal control unit) calculates a transmitter checksum (before the routing section in the accelerator pedal control unit) from the second accelerator pedal raw value by means of a calculation formula. The transmitter checksum is added to the second accelerator pedal raw value. A receiver calculation module (assigned to the assistance control unit) is provided in the course of the signal after the routing section. This calculates a receiver checksum using the same checksum calculation formula, namely from the received second accelerator pedal raw value. In addition, the checking module compares the transmitter checksum with the receiver checksum. If the transmitter checksum deviates from the receiver checksum, the checking module detects a transmission error.

The message counter (also assigned to the accelerator pedal) of the end-to-end protection increases a message count value by one increment for each sampling cycle of the second accelerator pedal raw value, for example by the value one. For each sampling cycle, the current message count value is added to the second accelerator pedal raw value. In the checking module of the assistance control unit, the message count value is checked for plausibility. In particular, it is checked whether the current message count value has increased in relation to the message count value of the last received second accelerator pedal raw value. In the event of non-plausibility, a transmission error is detected.

The checking module located in the assistance control unit generates a piece of checking information after the check has been completed. The checking module sets the checking information to an error value if the message count value checked in the checking module is not plausible and/or if the receiver checksum and the transmitter checksum do not correspond. Alternatively thereto, the checking module sets the checking information to an error-free value if the message count value checked in the transmitter checksum is plausible and the two checksums correspond. The checking information generated by the checking module is added to the second kickdown signal.

In the same way, the first signal path can also have an end-to-end protection, using which a signal transmission error in the first signal path is identifiable. In contrast to the second signal path, the calculation module and the message counter are not assigned to the accelerator pedal but to the accelerator pedal control unit. In the first signal path, the security data (i.e. the transmitter checksum and the message count value) are therefore not added to the first accelerator pedal raw value in the signal flow direction before the accelerator pedal control unit, but are added to the first accelerator pedal raw value directly in the accelerator pedal control unit.

A core concept of the invention is that both the section from the accelerator pedal to the accelerator pedal control unit and the section from the accelerator pedal control unit to the assistance control unit are protected with end-to-end protection. In order for the accelerator pedal control unit to be able to process the accelerator pedal raw values (for example for a latent error check), the accelerator pedal control unit has to unpack the data from both accelerator pedal raw values and check them for validity before they are supplied to the latent error check. The validity of these data is checked in the accelerator pedal control unit as part of the end-to-end protection. In addition, the second accelerator pedal raw value is forwarded to the assistance control unit with the security data SD (i.e. transmitter checksum CS and message count value BZ).

In a preferred embodiment variant, the two signal paths can be guided up to an evaluation module of the assistance control unit. The evaluation block has a signal connection to the program module of the first signal path and to the program module of the second signal path. Therefore, the evaluation module acquires the first kickdown signal with associated diagnostic information and with associated checking information, on the one hand. On the other hand, the evaluation module acquires the second kickdown signal with associated checking information. On this basis, the evaluation module detects a valid driver-side kickdown actuation, if the following conditions apply in combination:
the first kickdown signal K1 is set to K1=yes;
the diagnostic information added to the first kickdown signal is set to an error-free value;
the checking information added to the first kickdown signal is set to an error-free value;
the second kickdown signal K2 is set to K2=yes;
the checking information added to the second kickdown signal is set to an error-free value.

### BRIEF DESCRIPTION OF THE FIGURES

An exemplary embodiment of the invention is described below on the basis of the appended figures.

In the figures:

FIG. 1 shows a drive system for a vehicle in a schematic block diagram;

FIG. 2 shows an operating state of the drive system corresponding to FIG. 1;

FIG. 3 shows another operating state of the drive system corresponding to FIG. 1.

FIG. 4 shows another operating state of the drive system corresponding to FIG. 1.

FIG. 5 shows another operating state of the drive system corresponding to FIG. 1.

FIG. 6 shows another operating state of the drive system corresponding to FIG. 1.

### DETAILED DESCRIPTION

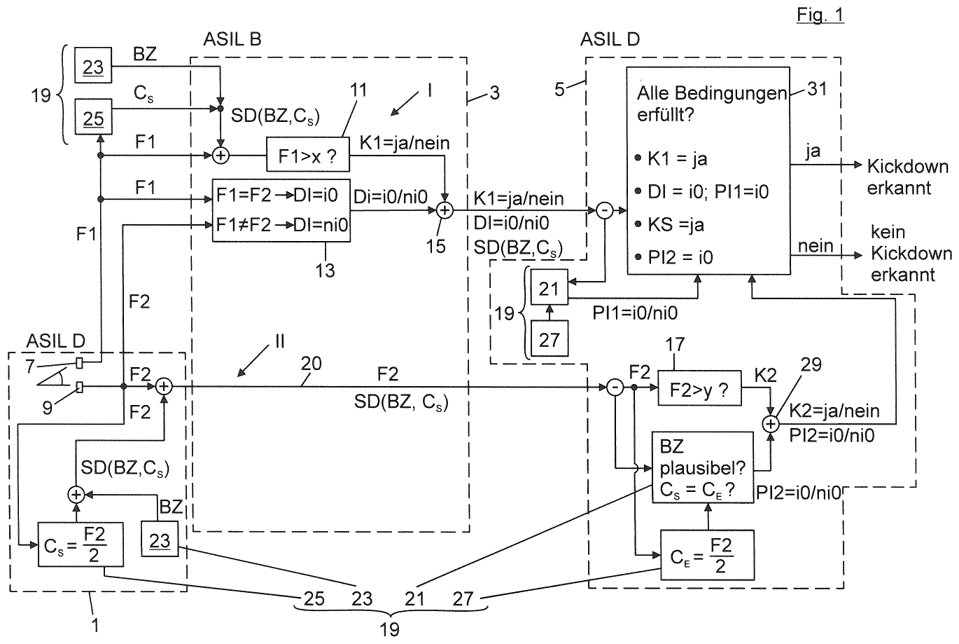

In FIG. 1, a drive system for a vehicle is shown in a block diagram to the extent necessary for understanding the invention. The program modules of the block diagram are selected with regard to easy understanding of the invention and do not reflect the actual software architecture in the drive system.

The drive system has an accelerator pedal 1 having an associated accelerator pedal control unit 3, which performs a driving task when the driver actuates the accelerator pedal. The accelerator pedal control unit 3 is connected as a transmitter control unit to an assistance control unit 5 as a receiver control unit. With the aid of the assistance control unit 5, a driver-independent, automated driving task can be performed without driver intervention. If the driver actuates a kickdown, the assistance control unit 5 deactivates the assistance function or the piloted function, so that the driver is again responsible for taking over the driving task. In the figures, the accelerator pedal 1 and the assistance control unit 5 each have a high safety integrity ASIL D, while the accelerator pedal control unit 3 has a reduced safety integrity ASIL B.

As can be seen from FIG. 1, two accelerator pedal sensors 7, 9 are assigned to the accelerator pedal 1. These acquire a first accelerator pedal raw value F1 and a second accelerator pedal raw value F2 independently of one another. The first accelerator pedal sensor 7 is connected to the accelerator pedal control unit 3 via a first signal path I and, in the further course of the signal, to the assistance control unit 5. In the same way, the second accelerator pedal sensor 9 is connected to the accelerator pedal control unit 3 via a second signal path II and, in the further course of the signal, to the assistance control unit 5.

In the accelerator pedal control unit 3, the signal of the first accelerator pedal raw value F1 is processed using a comparator module 11, which compares the first accelerator pedal raw value F1 with a kickdown limiting value y (for example y=95%). The comparator module 11 generates a kickdown signal K1. The kickdown signal K1 is set to “kickdown performed” (i.e. K1=yes) if the first accelerator pedal raw value F1 is greater than the kickdown limiting value y. If the first accelerator pedal raw value F1 is less than the kickdown limiting value y, the kickdown signal K1 is set to “no kickdown performed”, i.e. K1=no.

The accelerator pedal control unit 3 also checks for latent errors between the accelerator pedal raw values F1, F2 (for example drift errors) and discloses these errors.

This check is sufficient with ASIL B (ISO 26262-4:2018, 6.4.2.5). The latent error diagnosis is carried out using a diagnostic module 13, which compares the first accelerator pedal raw value F1 and the second accelerator pedal raw value F2 to one another. If there is a significant deviation between the two accelerator pedal raw values F1, F2, the diagnostic module 13 detects a latent error, for example a drift error. In this case, the diagnostic module 13 sets a piece of diagnostic information DI to an error value “niO”. Alternatively, the diagnostic module 13 does not detect a latent error if both accelerator pedal raw values F1, F2 correspond. In this case, the diagnostic module 13 sets the diagnostic information DI to an error-free value “iO”. According to FIG. 1, the diagnostic information DI generated in the diagnostic module 13 is added to the first kickdown signal K1 in a program module 15.

On the basis of the sensor information F1, the accelerator pedal control unit 3 forms not only the pieces of accelerator pedal information:
Accelerator pedal value, ASIL B(D)
Kickdown actuated, ASIL B(D)
Kickdown not actuated, ASIL B(D),

but also the following pieces of accelerator pedal information:
Accelerator pedal actuated, ASIL B(D)
Accelerator pedal not actuated, ASIL B(D)

In total, the accelerator pedal control unit 3 can only provide information with ASIL B(D), since the basic software/hardware of the accelerator pedal control unit 3 only provides measures against E/E errors with max. ASIL B(D).

In contrast to the first signal path I, in the second signal path II, the accelerator pedal raw value F2 is guided in the accelerator pedal control unit 3 via a routing section 20, along which the second accelerator pedal raw value F2 is transmitted to the assistance control unit 5 without signal processing.

The accelerator pedal control unit 3 therefore routes the accelerator pedal raw value F2 of the accelerator pedal 1 together with the security data SD described later to the assistance control unit 5. If a different bus protocol is used, “repackaging” into other bus messages may be required. Errors may also occur during “repackaging” and “routing”. These errors will be determined in the assistance control unit 5 using the security data SD.

According to the invention, the signal processing of the second accelerator pedal raw value F2 is not carried out in the accelerator pedal control unit 3, but only in the assistance control unit 5. The signal processing is carried out using a comparator module 17 that compares the second accelerator pedal raw value F2 with the kickdown limiting value y. The comparator module 17 sets the kickdown signal K2 to “kickdown performed”, i.e. K2=yes, if the second accelerator pedal raw value F2 is greater than the kickdown limiting value y. If the second accelerator pedal raw value F2 is less than the kickdown limiting value y, the kickdown signal K2 is set to “no kickdown performed”, i.e. K2=no.

Erroneous routing in accelerator control unit 3 can result in a signal transmission error in the second signal path II. To identify such a signal transmission error, an end-to-end protection 19 is provided, as is already known in principle from EP 2 454 865 B1. The end-to-end protection 19 has a receiver checking module 21 in the assistance control unit 5, which carries out protection by way of a checksum check and with the aid of a message counter 23.

For the checksum check, the end-to-end protection 19 has—in addition to the message counter 23—a transmitter calculation module 25. Both the message counter 23 and the transmitter calculation module 25 are assigned to the accelerator pedal 1. The transmitter calculation module 25 calculates a transmitter checksum Cₛ using a checksum calculation formula C_{S}=f(x). In practice, the calculation formula is a polynomial, for example CRC8 or 16 bit. In order to make the invention easier to understand, the calculation formula in the transmitter calculation module 25 and the receiver checking module 27 is indicated in a roughly simplified manner as follows: Cₛ=F2/2. In FIG. 1, the transmitter checksum Cₛ and the message count value BZ form the security data SD, which are added to the second accelerator pedal raw value F2 before the routing section 20. The security data SD are already generated in accelerator pedal 1, since this information has to be available with the highest safety integrity.

After the routing section 20, the end-to-end protection 19 has a receiver calculation module 27. This calculates a receiver checksum C_{E} using the same checksum calculation formula from the received second accelerator pedal raw value. In the receiver checking module 27, the transmitter checksum C_{S} is compared with the receiver checksum C_{E}. If the transmitter checksum C_{S} deviates from the receiver checksum C_{E}, the receiver checking module 27 detects a transmission error.

As already mentioned above, in FIG. 1 the message counter 23 and the transmitter calculation module 25 of the end-to-end protection 19 are assigned to the accelerator pedal 1. The accelerator pedal control unit 3 routes the second accelerator pedal raw value F2 together with the security data SD (i.e. the message count value BZ and the transmitter checksum C_{S})—without signal processing. The message counter 23 increases a message count value BZ by one increment, for example by one for each sampling cycle of the second accelerator pedal raw value F2. For each sampling cycle, the current message count value F2 is added to the second accelerator pedal raw value BZ. In the receiver checking module 21, the message count value BZ is checked for plausibility. In particular, it is checked whether the current message count value BZ has increased in relation to the message count value BZ of the last received second accelerator pedal raw value F2. In the event of non-plausibility, a transmission error is detected.

The receiver checking module 21 sets a piece of checking information PI2 to an error value iO, if the message count value BZ checked in the receiver checking module 21 is not plausible and/or if the receiver checksum C_{E} does not correspond with the transmitter checksum C_{S}. Alternatively thereto, the receiver checking module 21 sets the checking information PI2 to an error-free value iO if the message count value BZ checked in the transmitter checksum is plausible and the two checksums C_{E}, C_{S} correspond. The checking information PI2 generated by the receiver checking module 21 is added to the second kickdown signal K2 at a program module 29.

The first signal path I is also assigned an end-to-end protection 19, which is constructed essentially identically to the end-to-end protection 19 of the second signal path II described above, but is only indicated in the figures for reasons of clarity. In contrast to the second signal path II, in the first signal path I the security data SD of the end-to-end protection 19 (i.e. transmitter checksum C_{S} and message count value BZ) are added to the kickdown signal K1 in the accelerator pedal control unit 3 in order to meet the integrity ASIL B(D).

A core concept of the invention is that both the section from the accelerator pedal 1 to the accelerator pedal control unit 3 and the section from the accelerator pedal control unit 3 to the assistance control unit 5 are protected with end-to-end protection 19. This means that in order to be able to process the data (for example, latent error check in the diagnostic module 13), the accelerator pedal control unit 3 has unpack the data from both the accelerator pedal raw value F1 and the accelerator pedal raw value F2 and check them for validity before they are used, for example, for the latent error check.

The validity of these data is checked in the accelerator pedal control unit 3 as part of the end-to-end protection 19, which is not illustrated by program modules in the figures. The check for validity is carried out in the same way as described on the basis of the receiver checking modules 21 and the receiver calculation modules 27 in the assistance control unit 5.

In addition, the accelerator pedal raw value F2 is forwarded to the assistance system with the security data SD (i.e. transmitter checksum CS and message count value BZ).

The receiver checking module 21 sets a piece of checking information PI1 to an error value iO, if the message count value BZ checked in the receiver checking module 21 is not plausible and/or if the receiver checksum C_{E} does not correspond with the transmitter checksum C_{S}. Alternatively thereto, the receiver checking module 21 sets the checking information PI2 to an error-free value iO if the message count value BZ checked in the receiver checking module 21 is plausible and the two checksums C_{E}, C_{S} correspond. The checking information PI1 generated by the receiver checking module 21 is added to the first kickdown signal K1.

In the further signal course, both the first kickdown signal K1 (with added diagnostic information DI and checking information PI1) and the second kickdown signal K2 with added checking information PI2 are fed to an evaluation module 31, which is located in the assistance control unit 5. The evaluation module 31 detects a valid driver-side kickdown actuation, provided that the following conditions are met in combination:
first kickdown signal K1 set to K1=yes;
the diagnostic information DI added to the first kickdown signal K1 is set to an error-free value “iO”;
the checking information PI1 added to the first kickdown signal K1 is set to an error-free value “iO”;
second kickdown signal K2 is set to K2=yes;
the checking information PI2 added to the second kickdown signal K2 is set to an error-free value “iO”;

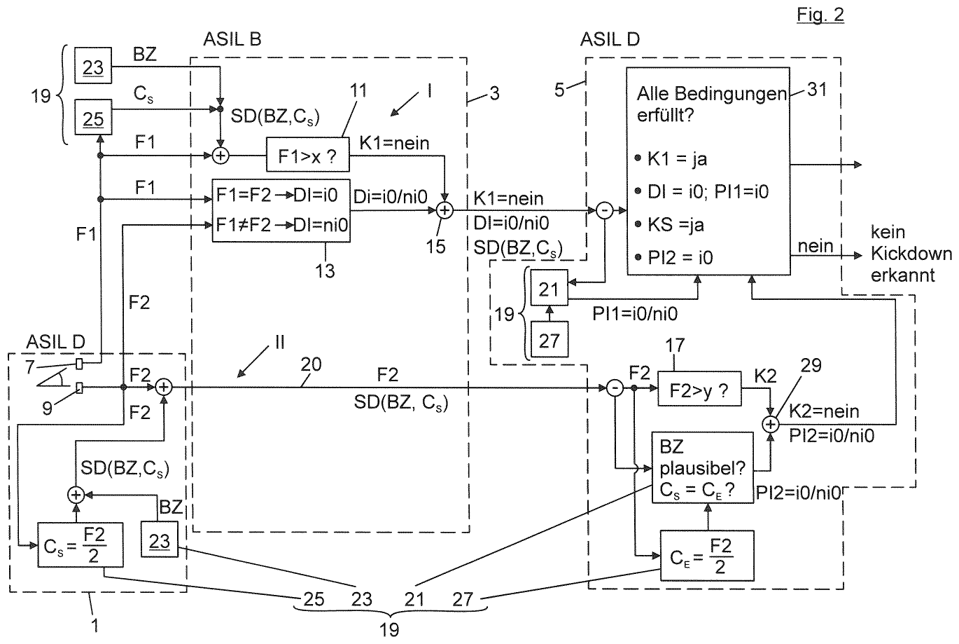

FIG. 2 describes error-free signal processing in the drive system in which the driver has not performed a kickdown actuation of the accelerator pedal 1. Accordingly, the two accelerator pedal raw values F1, F2 are at 0%. In both the accelerator pedal control unit 3 and the assistance control unit 5, the kickdown signals K1 and K2 are therefore set to K1=no and K2=no. On this basis, the evaluation module 31 detects that no valid driver-side kickdown actuation has been carried out.

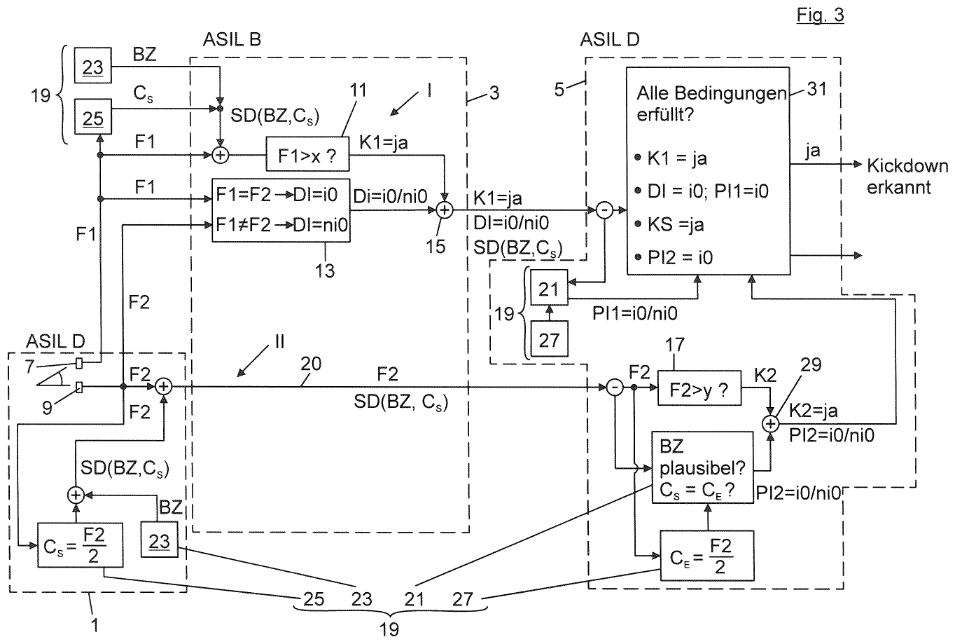

FIG. 3 also indicates error-free signal processing in which the driver has performed a kickdown actuation. Accordingly, the two accelerator pedal raw values F1, F2 are at 100%. In the accelerator pedal control unit 3, the first kickdown signal K1 is therefore set to K1=yes and in the assistance control unit 5, the second kickdown signal K2 is set to K2=yes. The diagnostic information DI determined in the accelerator pedal control unit 3 is set to an error-free value iO. Likewise, the pieces of checking information PI1, PI2 determined in the assistance control unit 5 are set to an error-free value iO. The evaluation module 31 of the assistance control unit 5 therefore detects that a valid driver-side kickdown actuation has been carried out.

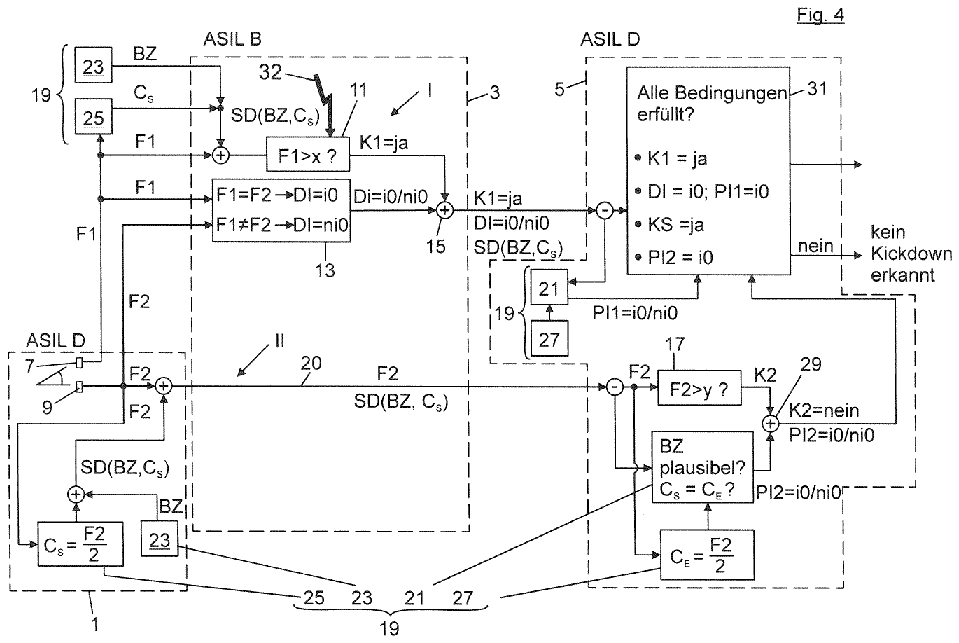

FIG. 4 shows an erroneous signal processing in which the driver has not performed a kickdown actuation, so that the two accelerator pedal raw values F1, F2 are at 0%. However, in FIG. 4, an error case 32 has occurred in the signal processing of the accelerator pedal control unit 3, in which the comparator module 11 incorrectly sets the first kickdown signal K1 to K1=yes. The evaluation module 31 therefore determines that the first kickdown signal K1 is set to K1=yes, but the second kickdown signal K2 is correctly set to K2=no. On this basis, the evaluation module 31 detects that no valid driver-side kickdown actuation has been carried out.

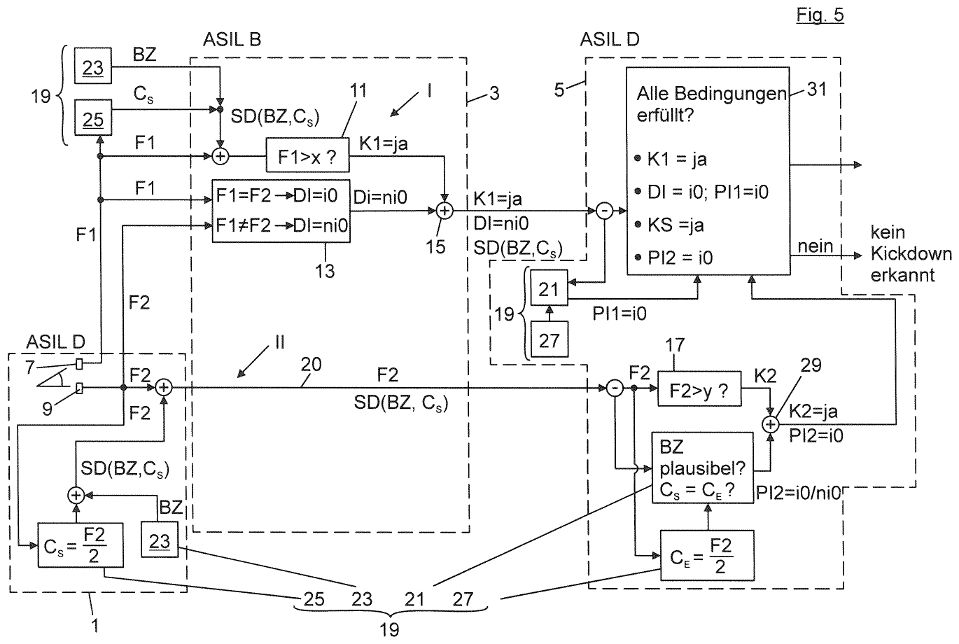

FIG. 5 indicates erroneous signal processing in which the driver has not performed a kickdown actuation, but a latent error (for example a drift error) has been detected during the latent error diagnosis in the accelerator pedal control unit 3. Accordingly, the accelerator pedal sensor 7 generates an erroneous accelerator pedal raw value F1 of 100%, while the second accelerator pedal sensor 9 generates an erroneous accelerator pedal raw value F2 of 96%. In the accelerator pedal control unit 3, the kickdown signal K1 is therefore set to K1=yes. In addition, the diagnostic information DI is set to an error value in iO in the accelerator pedal control unit 3, because the two accelerator values F1, F2 do not correspond. The first kickdown signal K1 is also assigned the checking information PI1, which is set to an error-free value iO.

In the latent error case according to FIG. 5, the second kickdown signal K2 is set to K2=yes in the assistance control unit 5. The checking information PI2, which is set to an error-free value “iO”, is added to the second kickdown signal K2. On this basis, the evaluation module 31 determines that, although both kickdown signals K1, K2 are set to K1=yes and K2=yes, the diagnostic information DI is set to an error value niO. The evaluation module 31 thus detects that no valid driver-side kickdown actuation has been carried out.

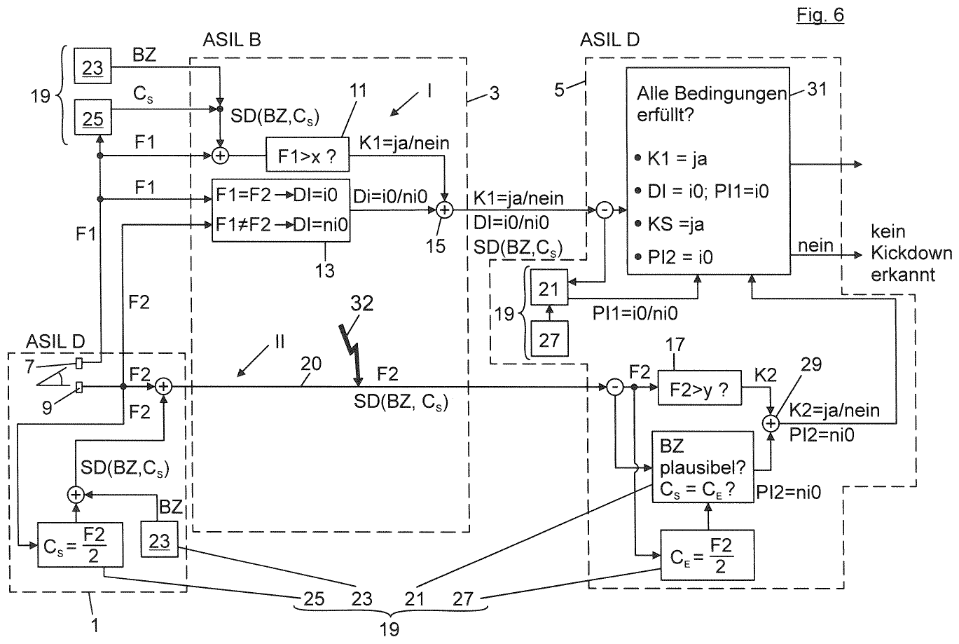

FIG. 6 indicates erroneous signal processing in which the driver has not performed a kickdown actuation, but an error case 32 has occurred in the routing section 20 of the accelerator pedal control unit 3, in which the second accelerator pedal raw value F2 is set from 0% to 100%. In this case, the transmitter calculation module 25 of the end-to-end protection 19 calculates a transmitter checksum C_{S} of 0%, while the receiver calculation module 27 of the end-to-end protection 19 calculates a receiver checksum C_{E} of 50%. By comparing the two C_{E} and C_{S}, the checking module 21 located in the assistance control unit 5 determines a non-plausibility, by which the transmission error on the routing section 20 in the accelerator pedal control unit 3 is detected. Therefore, a piece of checking information PI2, which is set to an error value niO, is added to the second kickdown signal K2. On this basis, the evaluation module 31 detects that no valid driver-side kickdown actuation has been carried out.

### LIST OF REFERENCE SIGNS

1 accelerator pedal control unit
5 assistance control unit
7,9 accelerator pedal sensors
11 comparator module
13 diagnostic module
15 program module
17 comparator module
19 end-to-end protection
20 routing section
21 receiver checking module
23 message counter
25 transmitter calculation module
27 receiver calculation module
29 program module
31 evaluation module
32 error case
y kickdown limiting value
I, II signal paths
ASIL automotive safety integrity level
DI diagnostic information
PI1, PI2 checking information
C_{E} receiver checksum
C_{S} transmitter checksum
F1 accelerator pedal raw value
F2 accelerator pedal raw value
SD security data
K1, K2 kickdown signals

1-10. (canceled)

11. A drive system for a vehicle, comprising an accelerator pedal having an associated accelerator pedal control unit which carries out a driving task when the driver actuates the accelerator pedal, wherein the accelerator pedal control unit is connected as a transmitter control unit to an assistance control unit as a receiver control unit which carries out a driver-independent, automated driving task, wherein the assistance control unit in particular deactivates the driver-independent, automated driving task when a valid kickdown actuation by the driver is present, wherein for reliable detection of a pedal actuation, in particular a valid kickdown actuation as a driver takeover request, the accelerator pedal is assigned two accelerator pedal sensors, which independently of one another each acquire a first accelerator pedal raw value and a second accelerator pedal raw value, that the first accelerator pedal sensor is connected via a first signal path to the accelerator pedal control unit and to the assistance control unit, and the second accelerator pedal sensor is connected via a second signal path to the accelerator pedal control unit and to the assistance control unit, that when a pedal is actuated, an actuation signal, in particular a kickdown signal is generated in each signal path, and that the assistance control unit checks error-free signal processing in the control units.

12. The drive system according to claim 11, wherein signal processing of the first accelerator pedal raw value takes place in the accelerator pedal control unit, namely using a comparator module which compares the first accelerator pedal raw value with a limiting value, in particular a kickdown limiting value, and that the comparator module sets the first actuation signal (K1) to (K1=yes) if the first accelerator pedal raw value (F1) is greater than the limiting value (y).

13. The drive system according to claim 11, wherein a latent error diagnosis is carried out in the accelerator pedal control unit, in which a diagnostic module compares the first and second accelerator pedal raw values (F1, F2) with one another, and that the diagnostic module detects a latent error in the event of a significant deviation between the two accelerator pedal raw values (F1, F2), so that the diagnostic module sets a piece of diagnostic information (DI) to an error value (niO), or that the diagnostic module does not detect a latent error if the two accelerator pedal raw values (F1, F2) correspond, so that the diagnostic module sets a piece of diagnostic information (DI) to an error-free value (iO), and that the diagnostic information (DI) generated in the diagnostic module (13) is added to the first actuation signal (K1).

14. The drive system according to claim 11, wherein routing takes place in the second signal path (II) in the accelerator pedal control unit, in which the second accelerator pedal raw value (F2) is transmitted to the assistance control unit via a routing section without signal processing.

15. The drive system according to claim 11, wherein signal processing of the second accelerator pedal raw value (F2) takes place in the assistance control unit, namely using a comparator module which compares the second accelerator pedal raw value (F2) with the limiting value (y), and that the comparator module sets the second actuation signal (K2) to (K2=yes) if the second accelerator pedal raw value (F2) is greater than the limiting value (y).

16. The drive system according to claim 14, wherein an end-to-end protection is provided, by means of which a signal transmission error in the first signal path (I) and/or in the second signal path (II) is identifiable, which error results from erroneous signal processing in the accelerator pedal control unit, and that the end-to-end protection in the assistance control unit has a receiver checking module which carries out a protection by way of a checksum check and by way of a message counter.

17. The drive system according to claim 16, wherein for the checksum check, a transmitter calculation module calculates a transmitter checksum (CS) from the accelerator pedal raw value (F1, F2) using a calculation formula (CS=f(x)), which checksum is added to the accelerator pedal raw value (F1, F2), in particular before the routing section, that a receiver calculation module calculates a receiver checksum (CE) from the received accelerator pedal raw value (F1, F2) using the same calculation formula (CE=f(x)), and that the receiver checking module compares the transmitter checksum (CS) with the receiver checksum (CE), and that the receiver checking module detects a transmission error if the transmitter checksum (CS) deviates from the receiver checksum (CE), and that in particular in the first signal path (I) the transmitter calculation module and the message counter are assigned to the accelerator pedal control unit, so that the transmitter checksum (CS) and a message count value (BZ) of the message counter are added in the accelerator pedal control unit to the first accelerator pedal raw value (F1), and that in particular in the second signal path (II) the transmitter calculation module and the message counter are assigned to the accelerator pedal (1), so that the transmitter checksum (CS) and a message count value (BZ) of the message counter are already added to the second accelerator pedal raw value (F2) in the accelerator pedal.

18. The drive system according to claim 16, wherein the message counter increases a message count value (BZ) by one increment for each sampling cycle of the second accelerator pedal raw value (F2), and that for each sampling cycle the current message count value (BZ) is added to the second accelerator pedal raw value (F2), and that the receiver test module checks the message count value (BZ) for plausibility, wherein in particular it is checked whether the current message count value has increased in relation to the message count value of the last received second accelerator pedal raw value (F2), and that the checking module detects a transmission error in the event of non-plausibility.

19. The drive system according to claim 18, wherein the receiver test module sets a piece of checking information (PI1, PI2) to an error value (niO) if the message count value (BZ) checked in the receiver test module is not plausible and/or if the receiver checksum (CE) and the transmitter checksum (CS) do not correspond, or that the receiver test module sets the test information (PI1, PI2) to an error-free value (iO) if the message count value (BZ) checked in the receiver test module is plausible and the two checksums (CS, CE) correspond, and/or that in particular the test information (PI1, PI2) generated by the receiver test module is assigned to the respective first or second actuation signal (K1, K2).

20. The drive system according to claim 13, wherein the two signal paths (I, II) are guided to an evaluation module of the assistance control unit, and that the evaluation module detects a pedal actuation by the driver, provided that the following conditions are met in combination in the evaluation unit:
first actuation signal (K1) set to (K1=yes);
the diagnostic information (DI) added to the first actuation signal (K1a) is set to the error-free value (iO);
the checking information (PI1) added to the first actuation signal (K1) is set to the error-free value (iO);
second actuation signal (K2) set to (K2=yes);
the checking information (PI2) added to the second actuation signal (K2) is set to the error-free value (iO).

21. The drive system according to claim 12, wherein a latent error diagnosis is carried out in the accelerator pedal control unit, in which a diagnostic module compares the first and second accelerator pedal raw values (F1, F2) with one another, and that the diagnostic module detects a latent error in the event of a significant deviation between the two accelerator pedal raw values (F1, F2), so that the diagnostic module sets a piece of diagnostic information (DI) to an error value (niO), or that the diagnostic module does not detect a latent error if the two accelerator pedal raw values (F1, F2) correspond, so that the diagnostic module sets a piece of diagnostic information (DI) to an error-free value (iO), and that the diagnostic information (DI) generated in the diagnostic module is added to the first actuation signal (K1).

22. The drive system according to claim 12, wherein routing takes place in the second signal path (II) in the accelerator pedal control unit, in which the second accelerator pedal raw value (F2) is transmitted to the assistance control unit via a routing section without signal processing.

23. The drive system according to claim 13, wherein routing takes place in the second signal path (II) in the accelerator pedal control unit, in which the second accelerator pedal raw value (F2) is transmitted to the assistance control unit via a routing section without signal processing.

24. The drive system according to claim 12, wherein signal processing of the second accelerator pedal raw value (F2) takes place in the assistance control unit, namely using a comparator module which compares the second accelerator pedal raw value (F2) with the limiting value (y), and that the comparator module sets the second actuation signal (K2) to (K2=yes) if the second accelerator pedal raw value (F2) is greater than the limiting value (y).

25. The drive system according to claim 13, wherein signal processing of the second accelerator pedal raw value (F2) takes place in the assistance control unit, namely using a comparator module which compares the second accelerator pedal raw value (F2) with the limiting value (y), and that the comparator module sets the second actuation signal (K2) to (K2=yes) if the second accelerator pedal raw value (F2) is greater than the limiting value (y).

26. The drive system according to claim 14, wherein signal processing of the second accelerator pedal raw value (F2) takes place in the assistance control unit, namely using a comparator module which compares the second accelerator pedal raw value (F2) with the limiting value (y), and that the comparator module sets the second actuation signal (K2) to (K2=yes) if the second accelerator pedal raw value (F2) is greater than the limiting value (y).

27. The drive system according to claim 15, wherein an end-to-end protection is provided, by means of which a signal transmission error in the first signal path (I) and/or in the second signal path (II) is identifiable, which error results from erroneous signal processing in the accelerator pedal control unit, and that the end-to-end protection in the assistance control unit has a receiver checking module which carries out a protection by way of a checksum check and by way of a message counter.

28. The drive system according to claim 17, wherein the message counter increases a message count value (BZ) by one increment for each sampling cycle of the second accelerator pedal raw value (F2), and that for each sampling cycle the current message count value (BZ) is added to the second accelerator pedal raw value (F2), and that the receiver test module checks the message count value (BZ) for plausibility, wherein in particular it is checked whether the current message count value has increased in relation to the message count value of the last received second accelerator pedal raw value (F2), and that the checking module detects a transmission error in the event of non-plausibility.

29. The drive system according to claim 14, wherein the two signal paths (I, II) are guided to an evaluation module of the assistance control unit, and that the evaluation module detects a pedal actuation by the driver, provided that the following conditions are met in combination in the evaluation unit:
first actuation signal (K1) set to (K1=yes);
the diagnostic information (DI) added to the first actuation signal (K1a) is set to the error-free value (iO);
the checking information (PI1) added to the first actuation signal (K1) is set to the error-free value (iO);
second actuation signal (K2) set to (K2=yes);
the checking information (PI2) added to the second actuation signal (K2) is set to the error-free value (iO).

30. The drive system according to claim 15, wherein the two signal paths (I, II) are guided to an evaluation module of the assistance control unit, and that the evaluation module detects a pedal actuation by the driver, provided that the following conditions are met in combination in the evaluation unit:
first actuation signal (K1) set to (K1=yes);
the diagnostic information (DI) added to the first actuation signal (K1a) is set to the error-free value (iO);
the checking information (PI1) added to the first actuation signal (K1) is set to the error-free value (iO);
second actuation signal (K2) set to (K2=yes);
the checking information (PI2) added to the second actuation signal (K2) is set to the error-free value (iO).
